(19) United States
(12) Patent Application Publication
(10) Pub. No.: US 2007/0153312 A1
(43) Pub. Date: Jul. 5, 2007

(54) System and method for tracking jobs associated with multi-function peripherals and user accounts

(76) Inventor: Walter Filbrich, Manhattan Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/323,734

(22) Filed: Dec. 30, 2005

(51) Int. Cl. G06F 3/12

(52) U.S. Cl. 358/1.13

(57) ABSTRACT

A system and method for tracking jobs associated with multi-function peripherals and user accounts is disclosed. The job information is sent from a user computer to a multi-function peripheral (MFP). The MFP has a memory module that is configured to store the job information. A job server polls the MFP, retrieving the job information from the memory module.

### CROSS-REFERENCE TO RELATED APPLICATIONS

This invention may utilize the invention disclosed in U.S. patent application Ser. No. 11/187,645.

### BACKGROUND OF THE INVENTION

1. Field of the Invention

This invention relates to the distribution, storage, and compilation of electronic data. More particularly, this invention relates to systems and methods for tracking jobs associated with multi-function printers and user accounts.

2. Description of the Related Technology

Organizations have an interest in monitoring and tracking the use of devices such as copy machines, scanners, facsimile machines, and printers. Companies, for example, may want to monitor use to be able to charge a specific user or client for usage of the device. Companies may also want to monitor usage to keep closer track of their costs in using such devices. With the integration of such devices into a multifunction device, it has become desirable to monitor all such uses. Particularly now with the integration of the functionality and practical use of such devices it is important to efficiently monitor use of multiple types of devices or functions with a single system.

There are known systems capable of monitoring the usage of devices such as printers. One such system is sold by “Equitrac.” That system is used on some printers and multi-function printers. The system utilizes and requires external hardware attached to the device. The external hardware provides a keypad and/or a card reader that is used to identify users and to authenticate their use of the device. Each job the user requests the device to perform is held in a server external to the device until the user authenticates his request at the device. Some of the drawbacks of this system are that it requires hardware external to the device, it requires an external server to store pending jobs, and it requires custom software installed on each user computer to submit the job to the device.

Another known system is sold by Hewlett Packard. That system does not require external hardware to authenticate and track print functions, but instead stores print job information in the memory of the device itself. The Hewlett Packard system, however, can only track usage of a printer. The system cannot track performance of copying, scanning, or facsimile jobs.

### SUMMARY OF CERTAIN INVENTIVE ASPECTS

In view of the foregoing, a need exists for a device usage tracking system that can track job information associated with the multiple types of jobs that can be performed by multi-function peripheral devices. A need also exists for a system that can perform such tracking without the need for an external user authentication device located at the device, but instead is able to acquire and store the job information in the multi-function device itself. Furthermore, a need exists for a system that can perform such tracking without the need for special job accounting software resident on each user workstation or computer.

One embodiment of this invention is a method of tracking job information relating to a multi-function computer peripheral device, said method comprising: providing job information to a multi-function computer peripheral device; recording job information in the memory of a multi-function computer peripheral device; storing job information in the memory of the multi-function computer peripheral device; retrieving the stored job information from the multi-function computer peripheral device; and compiling the stored job information on a computer or server.

In another embodiment, this invention is a system for tracking job information of a multi-function computer peripheral device, said system comprising: a multi-function computer peripheral device containing a memory storage device configured to record and store job information; a user computer connected to said multi-function computer peripheral device; and a computer or server connected to said multi-function computer peripheral device containing software to retrieve and compile job information stored in the memory of said multi-function computer peripheral device.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1A illustrates an exemplary diagram of a system for tracking jobs associated with multi-function peripherals and user accounts.

FIG. 1B illustrates an exemplary block diagram of a system for tracking jobs associated with multi-function peripherals and user accounts.

FIG. 2 illustrates an exemplary flowchart of a method for tracking jobs associated with multi-function peripherals and user accounts.

### DETAILED DESCRIPTION OF CERTAIN EMBODIMENTS OF THE INVENTION

Certain inventive features of the systems and methods will now be described with reference to the drawing summarized above. The drawings, associated descriptions, and specific implementation are provided to illustrate embodiments of the invention and not to limit the scope of the disclosure.

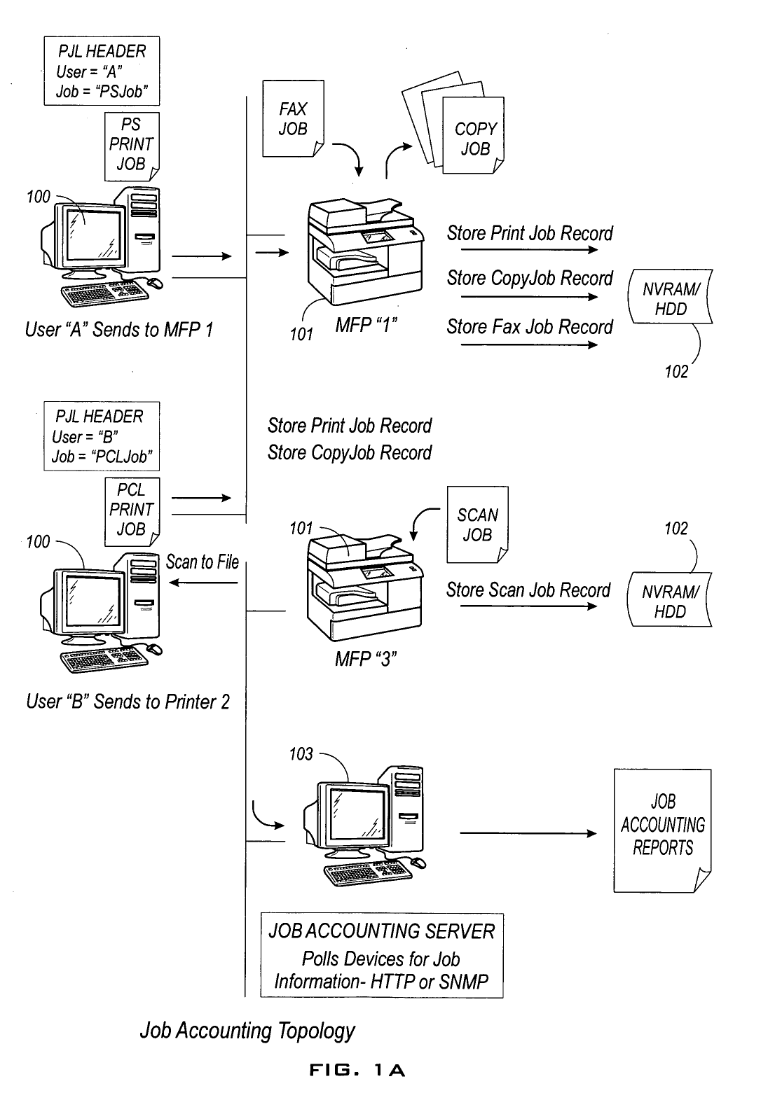

With reference to FIGS. 1A and 1B, a user computer 100 can be any workstation or computing device capable of sending a job request to a peripheral device. For example, the user computer can be a commercially available personal computer utilizing an Intel processor and Microsoft Windows Operating system. The user computer 100 may utilize user authentication software as is disclosed in U.S. patent application No. application Ser. No. 11/187,645, which is incorporated in its entirety. In general, the user computer 100 utilizes standard driver software associated with the multi-function peripheral device. The user computer 100 is connected, by any suitable data communications technology, to a multi-function peripheral (MFP) device 101. Preferably, the user computer 100 is connected via a data communications network to at least one multi-function peripheral device and a job accounting server 103.

One device 101 connected to the network is a multi-function peripheral device. This device includes a single device configured to perform multiple functions such as, for example, copying, printing, faxing, scanning, various combinations of the same and the like. For example, the device 101 may be capable of printing, copying, faxing and scanning.

The device 101 also contains a memory module 102. The memory module can be any suitable type of memory capable of recording and storing information. For example, the memory module may be the standard non-volatile random access memory (NVRAM) of the device. When the device's NVRAM is used as the memory module, the memory module will need to be cleared to allow storage of additional jobs after approximately fifty jobs have been performed. Such clearing of the memory module can be done by a job server application or any other application. For enhanced storage capabilities, the memory module may be, for example, a hard disk drive of any size, make or configuration. Use of a hard disk drive permits the device to hold more job information for a longer duration. As a result, the device can store more detailed job information and the job accounting server 103 does not have to poll the devices for information as frequently. The device 101 may also utilize user authentication software as disclosed in U.S. patent application Ser. No. 11/187,645.

The job accounting server 103 can be any suitable computing device capable of connecting to a multi-function peripheral device, retrieving information from the device, compiling information from the device, and generating a summary of the retrieved information. The job accounting server 103 contains a job accounting server application. This server application is capable of polling each device on the system and retrieving job information from each such device, including any multi function peripherals. When retrieving job information, the server application is capable of distinguishing between new and old job information (i.e., between job information it has already retrieved and job information it is retrieving for the first time). In some embodiments, the server application is capable of clearing the device's memory module of job information that has already been retrieved. In one embodiment, the server application polls devices by requesting information from the device's memory module using SNMP. In another embodiment, the server application polls devices by retrieving information from the device's embedded web page. In some embodiments, the server application has a record of each device on the network. In some embodiments, the server application is capable of detecting when a new device has been added to the network. In such an embodiment, the server application will then add any new device to the devices it polls for job information. In some embodiments, the server application may also be capable of compiling the job information and generating output summarizing or reporting the job information. In other embodiments, the compiling and generating of output may be performed by a different application, for example Microsoft Excel or another program capable of generating spreadsheets.

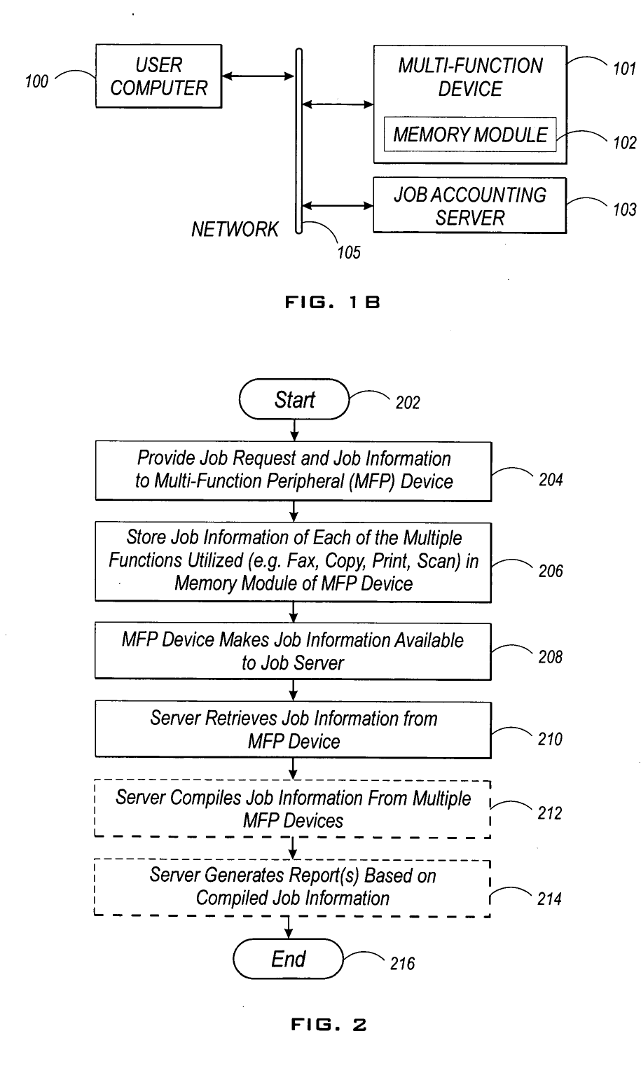

With reference now to FIG. 2, one embodiment of the method of the invention can be described as follows. In providing step 204, the job request and job information are sent to the multi-function peripheral device. In storage step 206, the job information associated with each of the multiple functions of the multi-function peripheral utilized by the job request is stored in the memory module of the multi-function device. Next, in step 208, the multi-function device makes the job information available to the job server. In retrieving step 210, the job server utilizes a server application to retrieve job information from the memory module of the multi-function device. In optional steps 212 and 214, an application on the server compiles the job information from the devices attached to the network and generates custom reports based upon the compiled job information.

One embodiment of the method of this invention is described as follows. Utilizing standard driver software associated with the multi-function device, the user computer 100 sends a job request and the associated job information to the multi-function device 101. The requested job can be any type of job that multi-function peripheral device 101 is capable of performing (e.g. printing or scanning). Job information associated with each job sent from the user to the multi-function peripheral device includes any information related to the job. By way of example, job information for a print job may include any of the following or any combination of the following: user name, job name, host name (e.g., the IP address of the user computer requesting the job), the number of sheets of each paper size and type used by the job, and/or the amount of consumables (e.g., print toner, staples) used in the job. By way of example, job information for a copy job may include any of the following or any combination of the following: user name, job name, the number of sheets of each paper size and type used by the job, the amount of consumables (e.g., print toner, staples) used in the job, and/or the number of sheets scanned. By way of example, job information for a scan job may include any of the following or any combination of the following: user name, job name, the number of sheets scanned, and/or the destination of scan jobs (e.g., computer file folder or electronic mail address). By way of example, job information for a fax job may include any of the following or any combination of the following: user name, job name, the number of sheets of each paper size and type used by the job, the amount of consumables (e.g., print toner, staples) used in the job, the number of sheets scanned, and/or the destination phone numbers for each job.

Multi-function device 101 performs the requested job and stores the associated job information in memory module 102. The memory module 102 makes the stored job information available to the job accounting server 103 by any method that allows job accounting server 103 to access and retrieve the job information. In one embodiment, the memory module 102 may utilize Simple Network Management Protocol (SNMP) to make the job information available to the job accounting server. SNMP is an application-layer protocol that facilitates the exchange of information between devices on a network. In such an embodiment, the preferred use of SNMP is the Job Monitoring MIB reported in Request for Comment No. 2707 of Internet Engineering Task Force (available at http://www.faqs.org/ftp/rfc/pdf/rfc2707.txt.pdf). In another embodiment, the memory module 102 may make the job information available via the device embedded web page, which can be accessed via HTTP at the device's IP address. In this embodiment, the job accounting server 103 may retrieve the file as a Comma Separated Value (CSV) file.

Periodically, the server application running on the job accounting server polls the memory modules of any MFP connected to the server. The job accounting server utilizes a server application that permits it to retrieve the job information from multi-function device 101. The job accounting server may also be capable of storing the retrieved job information and generating an output that reports or summarizes the job accounting data.

The embodiments described herein can be combined with any additional functions. For example, the job accounting capability may be combined with all other processing features such as secure print and saved jobs. The embodiments can function with non-secure accounting, without passwords or other authorizations or can be combined with user name and passwords supplied via the device user interface or external card readers.

What is claimed is:

1. A method of tracking job information relating to a multi-function computer peripheral device, said method comprising:
providing job information to a multi-function computer peripheral device;
storing job information in the memory of the multi-function computer peripheral device;
retrieving the stored job information from the multi-function computer peripheral device; and
storing the retrieved job information at a computer server.

2. The method of claim 1, wherein said storing the retrieved job information comprises compiling the retrieved job information on a server computer along with other retrieved job information which was previously stored.

3. The method of claim 1, wherein said multi-function computer peripheral device performs two or more functions selected from: printing, scanning, sending facsimiles, receiving facsimiles, copying, and scanning.

4. The method of claim 1, wherein said multi-function computer peripheral device functions as a printer, a copier, a facsimile machine, and a scanner.

5. The method of claim 1, wherein the job information includes one or more of: the identification of the user of the multi-function computer peripheral device, the identification of the job submitted to the multi-function computer peripheral device, the identification of the computer operated by the user of the multi-function peripheral device, the amount of paper used by the multi-function computer peripheral device, the amount of toner used by the multi-function computer peripheral device, the destination phone numbers for facsimiles, and the destination of scanned images.

6. The method of claim 1, wherein said storing comprises recording and storage in the non-volatile RAM (NVRAM) of the multi-function computer peripheral device.

7. The method of claim 1, wherein said storing comprises recording and storage in a hard disk drive associated with the multi-function computer peripheral device.

8. The method of claim 1, wherein said retrieving is performed by a server computer connected to the multi-function computer peripheral device.

9. The method of claim 1, wherein said retrieving comprises retrieving a comma separated values (CSV) file from the embedded web-page of the multi-function computer peripheral device.

10. The method of claim 1, wherein said retrieving step comprises retrieving the job information from a device utilizing simple network management protocol (SNMP).

11. A system for tracking job information of a multi-function computer peripheral device, said system comprising:
a user computer connected to a multi-function computer peripheral device;
a multi-function computer peripheral device containing a memory storage device configured to receive and store job information; and
a server computer connected to said multi-function computer peripheral device containing software to retrieve and compile job information stored in the memory of said multi-function computer peripheral device.

12. The system of claim 11, wherein the job information data includes one or more of: the identification of the user of the multi-function computer peripheral device, the identification of the job submitted to the multi-function computer peripheral device, the identification of the computer operated by the user of the multi-function peripheral device, the amount of paper used by the multi-function computer peripheral device, the amount of toner used by the multi-function computer peripheral device, the destination phone numbers for facsimiles, and the destination of scanned images.

13. The system of claim 11, wherein said multi-function computer peripheral device performs two or more functions selected from printing, scanning, sending facsimiles, receiving facsimiles, copying, and scanning.

14. The system of claim 11, wherein said multi-function computer peripheral device functions as a printer, a copier, a facsimile machine, and a scanner.

15. The system of claim 11, wherein said memory storage device is the NVRAM of the multi-function computer peripheral device.

16. The system of claim 11, wherein said memory storage device is a hard disk drive associated with the multi-function computer peripheral device.

17. A system for tracking job information of a multi-function computer peripheral device, said system comprising:
a user computer connected to said multi-function computer peripheral device;
a multi-function computer peripheral device including means for storing job information;
means for retrieving and compiling job information stored in the storing means.

18. The system of claim 17, wherein the job information includes one or more of: the identification of the user of the multi-function computer peripheral device, the identification of the job submitted to the multi-function computer peripheral device, the identification of the computer operated by the user of the multi-function peripheral device, the amount of paper used by the multi-function computer peripheral device, the amount of toner used by the multi-function computer peripheral device, the destination phone numbers for facsimiles, and the destination of scanned images.

19. The system of claim 18, wherein said multi-function computer peripheral device performs two or more functions selected from the group consisting of: printing, scanning, sending facsimiles, receiving facsimiles, copying, and scanning.

20. The system of claim 19, wherein said multi-function computer peripheral device functions as a printer, a copier, a facsimile machine, and a scanner.
